(19) United States
(12) Patent Application Publication
(10) Pub. No.: US 2011/0096137 A1
(43) Pub. Date: Apr. 28, 2011

(54) Audiovisual Feedback To Users Of Video Conferencing Applications

(76) Inventors: Mary Baker, Palo Alto, CA (US); Daniel George Gelb, Redwood City, CA (US); Ramin Samadani, Palo Alto, CA (US)

(21) Appl. No.: 12/606,318

(22) Filed: Oct. 27, 2009

(51) Int. Cl. H04N 7/15

(52) U.S. Cl. 348/14.08; 348/E07.083

(57) ABSTRACT

The present invention provides a method of providing feedback to a participant in a video conference, comprising the steps of: establishing a video conferencing session between multiple participants, wherein each participant in the video conferencing session is associated with a video capture device and an audio capture device; and establishing presentation requirements for each participant, wherein the presentation requirements are associated with the video conferencing session and the video capture and audio capture devices associated with each participant, wherein responsive to a failure to meet the presentation requirements, feedback is sent to at least the local participant who has failed to meet the presentation requirements.

### CROSS REFERENCE TO RELATED APPLICATION

The present application shares some common subject matter with co-pending and commonly assigned U.S. patent application Ser. No. ______, filed on October x, 2009, and entitled “Analysis of Video Composition of Participants in a Video Conference,” the disclosure of which is hereby incorporated by reference in it's entirety.

### BACKGROUND

Users of remote conferencing applications may not be aware of whether they are seen or heard clearly by other participants in the video conference. Some video conferencing systems, such as the Halo Video Conferencing system developed by Hewlett-Packard Company, have dedicated conference rooms which include tables and chairs that are designed to position meeting participants to ensure that they well aligned with the conferencing system's cameras and microphones. This careful design increases the likelihood of video conference participants receiving well framed video with audio having sufficient volume.

Unfortunately video conferencing applications that allow users to join meetings in an ad hoc fashion using cameras and microphones attached to a PC or laptop, cannot rely on this careful design. To provide information to the local user as to how they are viewed by remote participants in the video conference, some remote conferencing applications continuously display video of the local user along with video of all the other video conference participants on the user's screen. While this continuous display does provide visual feedback to the user about the local user's framing, this continuous display can be distracting. It has been found that people are easily distracted by seeing video of themselves during a meeting, making it difficult for the participant to concentrate on the meeting itself.

Since remote users may not be aware of their position in the video, some existing systems use motorized pan/tilt cameras in combination with face detection techniques to attempt to keep a user in frame automatically. These systems require additional hardware components which add cost and size limitations to the system. In addition, a moving camera view can be distracting to remote viewers, especially if the camera motion is jerky or unnatural. These systems may also have difficulty when there are multiple users in view of the camera.

A system and method which can provide the local user in a video conference information regarding how their presentation is being viewed by other remote participants in the video conference without being unduly distracting or adding significant systems cost is needed.

### BRIEF DESCRIPTION OF THE DRAWINGS

The figures depict implementations/embodiments of the invention and not the invention itself. Some embodiments of the invention are described, by way of example, with respect to the following Figures:

FIG. 1A shows a video conferencing configuration according to one embodiment of the present invention.

FIG. 1B shows a typical display of the remote participants active in the video conference shown in FIG. 1A according to one embodiment of the invention.

FIG. 1C shows an alternative video conferencing configuration according to one embodiment of the present invention.

FIG. 2A shows a view of the remote participant that the local user would have when the presentation requirements are being met according to one embodiment of the present invention.

FIG. 2B shows the visual feedback given to the local participant in a video conference according to one embodiment of the present invention where the visual feedback is a blended view of the local user and a remote participant.

FIG. 3 shows flowchart of the method of providing audiovisual feedback to a local participant regarding his presentation to remote participants according to one embodiment of the present invention.

FIG. 4 illustrates a block diagram of a computing system configured to implement or execute the method shown in FIG. 3 according to one embodiment of the present invention.

### DETAILED DESCRIPTION

Many remote conferencing applications allow a user to join a meeting via his PC or laptop using a camera and a microphone attached to his PC. If the user does not remain properly framed within the view of the camera or properly facing the camera, other meeting participants may not be able to see him well. In addition, if the user does not speak up clearly or is in a noisy environment, other meeting participants will not be able to hear him well. However, even though the other participants know of the poor framing or audio, the local user may not know that the other participants are receiving poor audiovisual content. We solve this problem by providing dynamic feedback to the user to allow him to know when he has moved outside the view of the camera or has turned away so that he is not providing a face-front view to the camera. We also provide dynamic audio feedback to the user to know if he is speaking sufficiently loudly and without too much extraneous noise.

We present methods for providing dynamic feedback to users about whether they are well framed and posed within the view of the video camera and whether they are providing a sufficiently loud and clear audio signal. The method comprises the steps of: establishing a video conferencing session between multiple participants, wherein each participant in the video conferencing session is associated with a video capture device and an audio capture device, wherein each participant has presentation requirements associated with their video conferencing session and their video capture and audio capture devices, wherein responsive to a failure to meet the presentation requirements, feedback is sent to the participant who has failed to meet the presentation requirements.

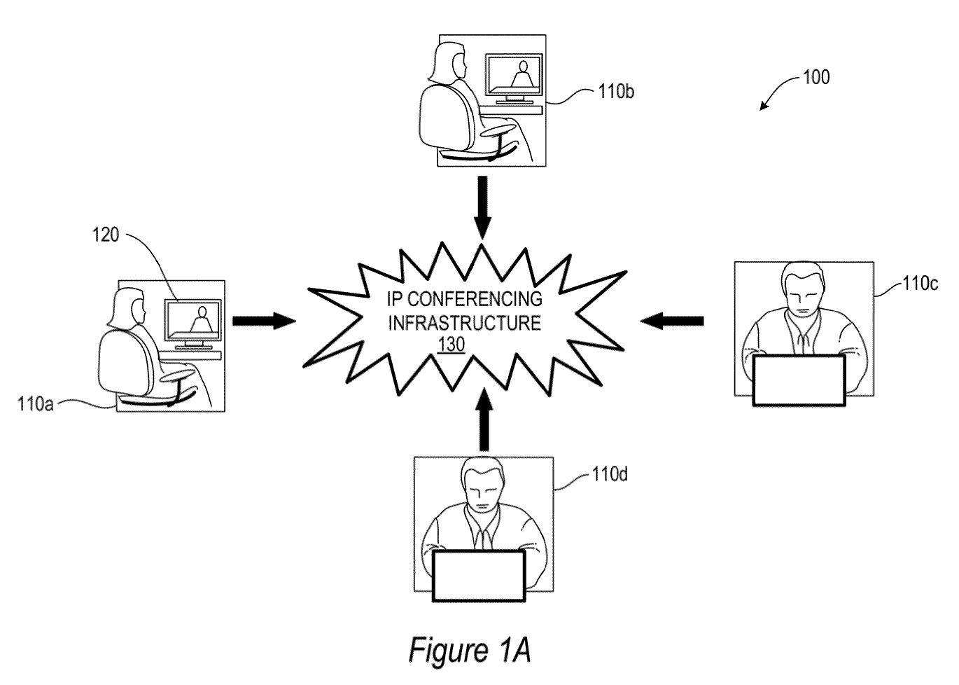

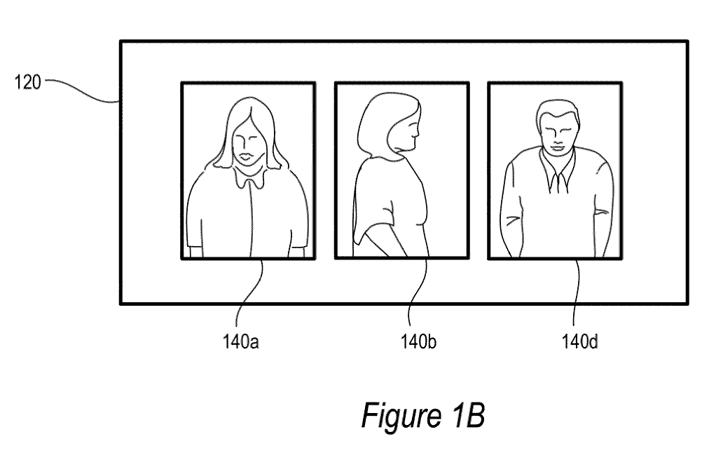

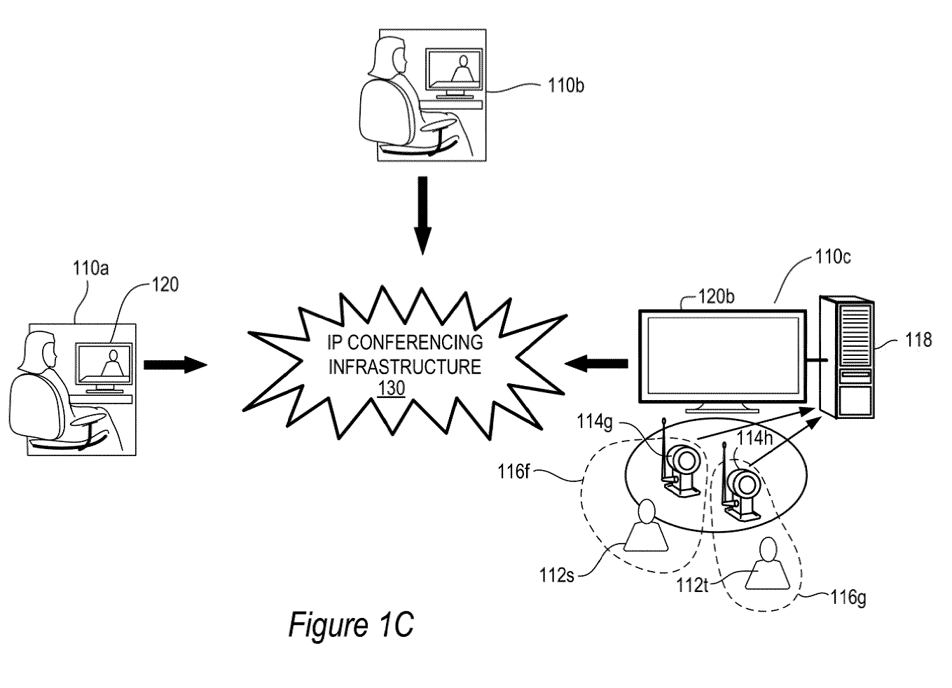

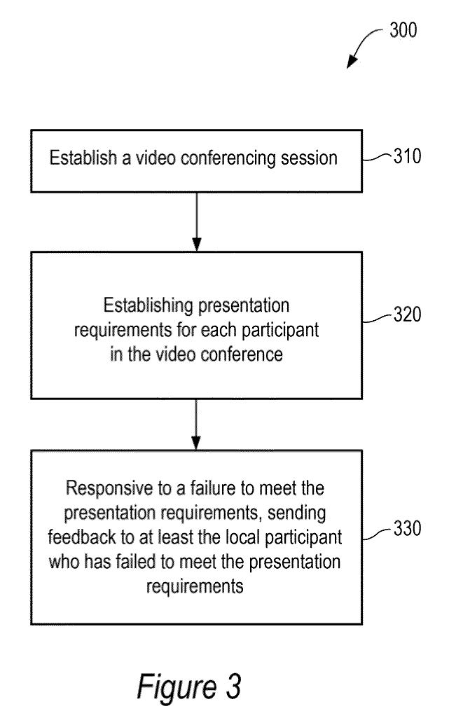

FIG. 3 shows flowchart of the method of providing audiovisual feedback to a local participant regarding his presentation to remote participants according to one embodiment of the present invention. Referring to FIG. 3, step 310 is the step of establishing a video conferencing session. Referring to FIG. 1A shows a video conferencing configuration 100 that could be used to implement the feedback mechanism of the present invention according to one embodiment of the invention. For purposes of example, the video conferencing system shown consists of four participants communicatively coupled to and interfacing with the IP Conferencing infrastructure 130 through their computer systems (either laptops 110c, 110d or desktops 110a, 110c). Each computer system is associated with a video capture device and an audio capture device that captures the audio and video associated with the present invention. In one embodiment a camera capable of capturing audio and video associated with a participant is mounted onto the display screen of the computer. In an alternative embodiment, the audio and video capture devices are integrated into the computer system (not shown).

In the present invention, the participants see a video of the other remote participants. In one embodiment (where each participant is associated with a single audio capture and video capture device), each participant sees a different view or display. Because it is common for different participants to have different views, to distinguish the participant's view whose perspective we are taking from other participants in the conference, we refer to this view as view of the local participant. The other participants, whom are being viewed by the local participant, are referred to as the remote participants or the remote users. Thus for example, if we are viewing the video conference from the eyes of or the perspective of participant 110c in the video conference, we refer to participant 110c as the local user or local participant. The participants 110b, 110a, and 110d would be referred to as the remote users or remote participants.

Referring to FIG. 1B shows the display 120 that the local user would see of the other video conference participants according to one embodiment of the present invention. The display 120 in FIG. 1B, is the display of the computer screen of the local user 110c. In other words, the screen 120 that is shown in FIG. 1B is what the local user 110c would see while viewing the video conference. The display seen in FIG. 1B is the display that would be seen under normal operating conditions. By normal operating conditions we mean that the video conferencing system is operational and that the local user is meeting the presentation requirements of the video conferencing session. Typically when the presentation requirements are met, no audiovisual feedback is being sent to the local user—only the video feed or display of the remote participants (as shown in FIG. 1B) is displayed on the local user's computer screen.

Referring to FIG. 3, step 320 is the step of establishing presentation requirements to each participant in the video conference. The presentation requirements are designed to provide an immersive experience to the user so that the participants can pay attention to the content being presented in the video conference itself without undue distraction. The presentation requirements for a video conferencing session often include, but are not limited by the following considerations: framing (defines the alignment of the participant in the video frame), pose (the position of the participant relative to the camera, for example, having the participant facing the camera so that both eyes are visible), proper positioning (participant's distance from the camera), audio volume (whether the volume of the participants is adequate and can be clearly heard), a high signal to noise ratio, etc.

Different techniques may be used to measure and analyze the video content and audio content to determine whether presentation requirements have been met. For example, the volume of the audio captured by the audio device for the local participant might be compared to maximum and minimum decibel values to determine if the audio is within an appropriate range for the video conferencing session. For example, the related case “Analysis of Video Composition of Participants in a Video Conference”, having serial number xx/xxx,xxx filed October x, 2009, which is incorporated herein by reference in it's entirety, describes a system and method of determining whether a participant in a video conference is in frame and posed correctly within the video frame.

As previously stated, presentation requirements are designed to provide an immersive experience to the user. Part of the immersive experience, is that during the video conference feed where presentation requirements are met, it is desirable that the video conference participants not be unduly distracted. Referring again to FIG. 1B, unlike some video conferencing configurations where a real time video stream of the local user is displayed on the local user's screen. The present invention does not continuously display a realistic view of the local user as it is seen as being too distracting. Instead, the present invention displays realistic views of the remote users 110a, 110b, and 100d only. Referring to FIG. 1B, view 140b corresponds to remote user 110b, view 140a corresponds to remote user 110a and view 140d corresponds to the video stream of remote user 110d.

FIG. 1C shows an alternative video conferencing configuration 100 that could be used to implement the feedback mechanism of the present invention. The video conferencing system is similar to the embodiment shown in FIG. 1A in that it shows two individual participants each connecting to the IP Conferencing Infrastructure 130 through their computers (in this case desktops 110a, 110b). However, in the embodiment shown in FIG. 1C, the video conference is connected to a meeting room 110c that has multiple participants who are participating in the conference. The multiple participants are connected to the IP Conferencing Infrastructure 130 via server 118.

The participants (112s, 112t) in the meeting room are captured by cameras 114g and 114h that are capable of capturing the audio and video of the associated participant. In the embodiment shown in FIG. 1C, camera 114g captures the video and audio associated with participant 112s and camera 114h captures the video and audio associated with participant 112t. In the embodiment shown in FIG. 1C, each participant in the video conference is associated with a single video and audio capture device. However, it is possible for more than one participant to be associated with a single audio and video capture device. For example, a single video camera might be associated with multiple participants. The case of more than one participants associated with a single video and/or audio device can pose implementation difficulties. Specialized software (that typically includes face detection software) may be required to distinguish between participants in the event that only a single participant in the group was not meeting the presentation requirements.

Although the displays shown in FIG. 1B avoids the problem of distraction due to a photo-realistic video stream of the local user being continuously displayed, the views of the remote participants that are displayed during normal operation do not allow the local user to see whether they are properly framed or whether their speaking volume is too loud or too soft. The present invention provides feedback to the local user when he or she is not meeting the presentation requirements of the video conference (step 330).

Feedback to the local user may be audio or visual or a combination of the two, but typically the feedback acts as a visual or audio cue as to how the local user should change his current behavior in order to meet the current presentation requirements of the video conference. For example, if the local participant is not properly positioned within the video frame according to the presentation requirements of the video conference, the video feed may switch from a view of the remote participants to a video of the local participant Superimposed on the video of the local participant might be arrows pointing in the direction that the local participant should move.

One method of determining whether a participant in a video conference is framed properly within the video frame is described in the pending application “Analysis of Video Composition of Participants in a Video Conference.’ Once we know that the user is not properly positioned in the video frame, the present invention describes several methods of providing visual feedback to the user. For example, the local user may not meet the presentation requirements due to the fact that he or she is not framed properly within the video frame. In this case, the local user receives feedback to correct his position. In one embodiment, the feedback given to the local user is a distortion of the local user's view, where the local user's view of the remote participant is distorted in order to provide a parallax effect. The parallax effect creates an off-center view of the remote participants. This off-center view of the remote participants provides a visual cue to the local user that they also may not be properly centered or framed. As the local user moves back to the correct (properly framed within the video frame) position, the local user's view of the remote participants changes. As he moves back into the correct position, the remote participants also appear to him to move back to the correct position.

In one embodiment, the parallax view feedback is activated only when the local user moves too far from the center of the camera's view. The parallax view feedback can be activated gradually as a function of position so that the parallax effect becomes more pronounced as the local user moves further from the center of the camera view.

In another embodiment of the present invention, visual feedback is provided to the local user when the local user does not meet the framing presentation requirements of the video conference, by fading out the local user's view of the remote participants. As the local user moves too far from the center of the frame, the local user's view of the remote participant fades. As the local user moves closer to the center of the frame, his view of the remote participants becomes clearer.

In another embodiment of the present invention, visual feedback is provided to the local user by discoloring at least a portion of the video frame. For example, suppose the local user is not meeting the framing presentation requirements and has drifted off center in the video frame. For example in one embodiment, the local user's view of the remote participants could be discolored so that it is a glowing red color on the side that the local user has drifted off center. This visual feedback might instinctively cause the local user to move away from the glowing red side, effectively repositioning himself in the center of the camera's view.

Previously discussed embodiments describe systems and methods where the view of the remote user was modified visually responsive to framing presentation requirements not being met. However, methods that involve modifying and presenting a view of the local user may also be used. For example, instead of the feedback being a modification of the view of the remote participants, in one embodiment the local user sees an abstracted view of himself. In this case, the local user sees a non-photo-realistic image of himself, for example as a sillouhette in one embodiment, that provides feedback regarding the local user's positioning problems.

Typically during normal operation where the presentation requirements are being met, the local user does not see a view of himself as it is deemed to be too distracting. In one embodiment, the view of remote participants 140a, 140b, 140d is replaced entirely with the non-photo-realistic image until the local user correctly repositions himself. In another embodiment, the non-photo-realistic image is a thumbnail image placed on the display screen along with the views (140b, 140a, 140d) of the remote participants. The size of the abstracted non-photo-realistic image can also vary. For example, the size of the abstracted image could be a small thumbnail, but as time progressed and the local user did not respond to the framing requirements, the size of the thumbnail image could grow to cover the remote participant images and the entire screen.

The abstracted non-photo-realistic image could be created by separating out the image of the local user from his surroundings, and provide a thumbnail of the mask image. This method should create a silhouette of the local user, thus the local user will see his silhouette as it is framed by the camera. If the user is too far from the center view, his silhouette will also appear off center. In one embodiment, this abstracted image is a simple silhouette. In another embodiment, the abstracted non-photo realistic image could be based on the gray levels of the image. For this embodiment, the gray levels could be replaced with a chosen color, such as red, to bring attention to the local user when his image when it is poorly centered.

As previously stated, the realtime unmodified video capture of the local user (where details/features/expressions are observable) can often be distracting to the user. The abstracted silhouette image is designed not to be too distracting and in one embodiment is continually displayed as a thumbnail image. The problem with the continual display of the abstracted image is that if it is image is not prominent, the feedback of the silhouette could easily be ignored by the local user when an actual problem in the presentation (local user off-center) occurs. In this case, it would still be desirable to bring the potential problem presentation requirements prominently to the attention to the local user. In one embodiment, the local user might be notified perhaps by changing the silhouette to the chosen color or expanding the size of the silhouette as time progressed and the local user did not take any action.

In one embodiment, visual feedback is provided by providing the local user a view of himself when the presentation requirements are not met. Typically, the local user will be viewing the remote participants 140b, 140a, 140d. For example, we can provide the local user a view of his local scene, but only when there is a problem with his positioning. Changing the view to the local user indicates there is a problem and provides immediate visual feedback so the user can quickly understand the nature of the problem and react appropriately. The local user immediately sees a view of himself incorrectly centered, for example, and would correctly repositions himself. The local view would fade away or disappear after the local user correctly repositions himself.

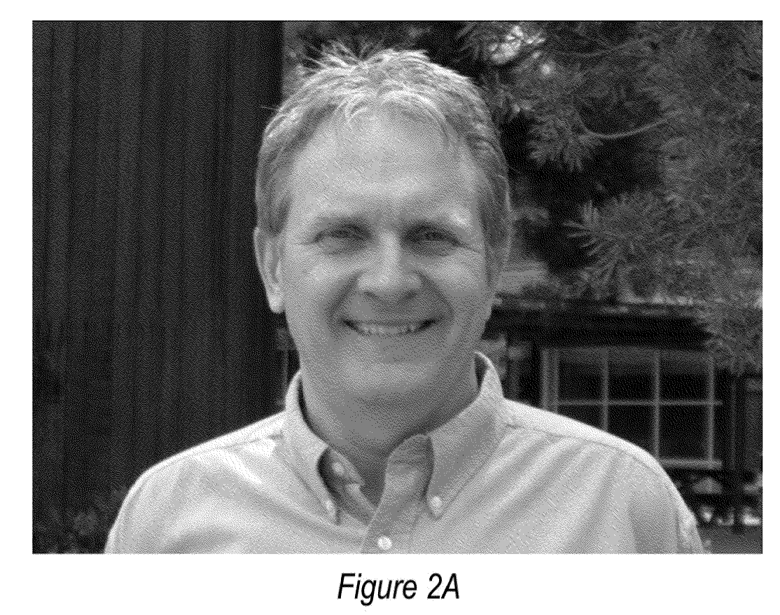

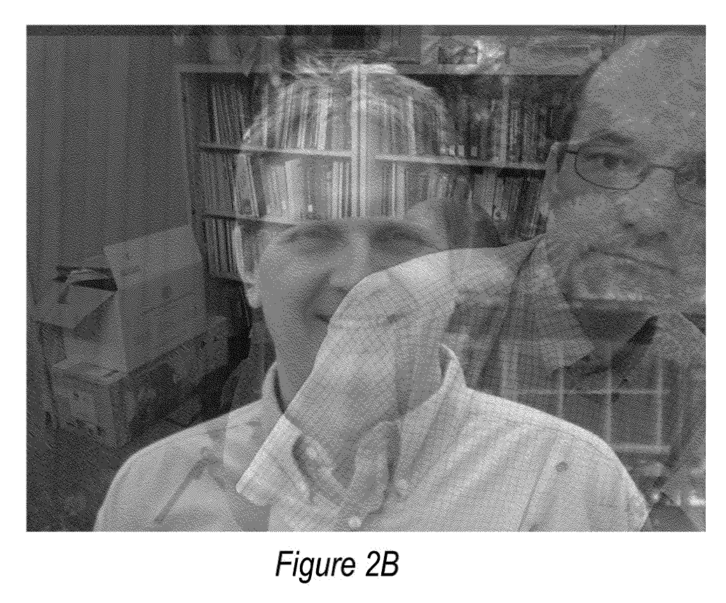

For simplicity, when referring to the embodiment shown in FIG. 2A, assume that there is a single local user and a single remote user participating in the video conference. Referring to FIG. 2A shows the view (i.e. a computer display) that the local user might have of a remote participant during the video conference when the presentation requirements were being met. However, if the local participant does not meet the presentation requirements, say for example by leaning to far to the right so that he is not well framed, in one embodiment a blended view appears. Referring to FIG. 2B shows a blended view of a local user and a single remote participant. The blended view returns to a view solely of the remote participant (FIG. 2B) when the local user corrects his position so that he meets the presentation requirements. In one embodiment, the blended view is weighted, so that the worse the local participant's positioning is (for example, the more off center or alternatively the longer the participant is poorly positioned) center) the clearer the view of the local participant.

In one embodiment, visual feedback is provided to the local user in the form of intuitive icons. For instance, in one embodiment the intuitive icons are arrows that indicate to the local user which direction he or she should move to be properly framed. We can analyze the video content to provide “arrow” overlays that tell the user to move left, right, up or down and composite them on top of the remove view when the local user is improperly framed and does not meet the presentation requirements. Optionally, the arrows can be supplemented with instructional text (print text on the display that says “Please move to the right in the direction of the arrow)” or voice activated text.

In one embodiment, where the camera captures a wider field of view than the display shows, we can use a “cropped” area as visual feedback that the local user is out of frame.

If the local user moves off-screen, we can increase the display of the window size and highlight the parts of the scene that are off screen. In one embodiment, the off-screen areas are highlighted by a color, for example yellow.

Presentation requirements are typically designed and executed by the software that controls the video conferencing session. In one embodiment, one set of presentation requirements are set for all of the audio and video captured by the devices. In another embodiment, different presentation requirements might be set for different audio and video devices that are participating in the conference. For example, if a camera associated with one participant had a wider angle view than other participants, as feedback this camera might crop the video frame for the local participant, whereas another local participant with a less sophisticated camera might just receive a view of the local participant when the presentation requirements were not met.

In another embodiment, a remote participant (who is displeased by the local user's presentation) can change the display of the local user so that the local user sees only his local view and not the remote participants. When the local user fixes the problem, he will again be allowed to see the remote participants. In another embodiment, the remote user can provide a variety of feedback to indicate his displeasure with the user's presentation. This feedback could be another type of visual feedback or audio feedback, or even motion or vibration in some instances.

Most of the techniques previously described that provide visual feedback to the local user regarding his proper positioning or framing, can also be used to guide the user to maintain the appropriate distance from the camera. In this case, the local user is not meeting the distance presentation requirements because they are too close or alternatively too far away from the camera. In one embodiment, the face size suggests to the local user which direction to move with respect to the camera. For cases where the local user is too close to the camera, the participant(s) or abstracted images will appear too close or too large—signaling to the local user to move further away from the camera. Whereas for cases where the local user is too far away, the displayed participant(s) or abstracted images will appear too small or too far away—signaling to the user to move closer to the camera.

The previously described embodiments could be used to give visual feedback to the local user when the posing presentation requirements are not met. By posing presentation requirements, we mean the requirement for the local user to be facing the camera instead of showing a sideways profile or other viewing angle. When the local user is not facing the camera, we provide feedback to the user that suggests to the local user that his pose should be modified. For example, in one embodiment, a highlighted silhouette of the user is displayed to the user so that he is notified whether he is facing the camera head-on or looking to the side. When posing requirements are not being made, in some instances it may be valuable to provide audio feedback in addition to visual feedback. Say for example, in addition to presenting the silhouette of the user, an audio message may occur instructing the local user to “Please turn your face towards the camera.”

Similar to the visual presentation requirements, the present invention also has audio presentation requirements that are designed to provide a good audio user interface. Similarly our system can provide feedback when audio acquisition is not yielding sufficiently high quality audio signals—where audio quality is judged by the volume and signal-to-noise ratio of the audio signal. When the presentation requirements for audio quality are not met, feedback is provided. The advantages of our audio feedback methods are that they provide the user feedback about local audio problems when he did not previously have that information. For example, feedback can be provided when the audio does not fall within the desired volume range, either too loud or too soft. Feedback can be provided when the required signal-to-noise ratio is not met and it is determined that the ambient noise levels in the area surrounding the local user may be interfering with audio acquisition of the local speaker.

Feedback regarding whether the audio presentation requirements are being met can either be audio or visual. For example, in one embodiment visual feedback on the audio quality of the local user's speech can be shown as a graphical representation of signal strength. In one embodiment, bars (or the analog audio signal) can be used to visually display whether the volume and signal to noise presentation requirements are being met. In one embodiment, if the signal is in the red it is bad (too soft or too loud or too much ambient noise). A signal within the green range would be good. Looking at the graphical representation, the local user receives feedback as to how he can modulate his voice or the surrounding room conditions.

In the present invention, audio feedback is given to the local user regarding whether the audio presentation requirements are being met. In one embodiment, voice instructions can be provided to the user informing them of detected audio issues. For example, voice instructions such as “Please speak louder” could be given to the local user. Different types of audio distortions can be applied to the audio delivered to the local user in order to provide cues about audio problems. For example, simulated audio feedback could be played when the microphone signal is too loud. Since people tend to speak more loudly when the person they are interacting with is perceived by them as speaking too softly, in one embodiment we reduce the volume level of the remote participants, when the local user is speaking too softly causing their audio to break up.

Some or all of the operations set forth in the methods shown in FIG. 3 and described in the present application may be contained as a utility, program, or subprogram, in any desired computer accessible medium. In addition, the methods may be embodied by computer programs, which can exist in a variety of forms both active and inactive. For example, they may exist as software program(s) comprised of program instructions in source code, object code, executable code or other formats. Any of the above may be embodied on a computer readable medium, which include storage devices.

Exemplary computer readable storage devices include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

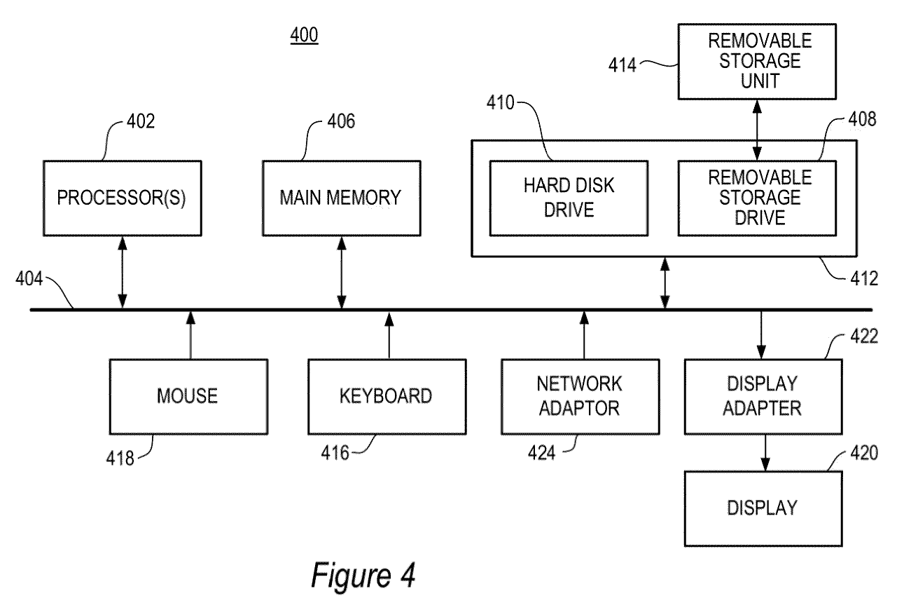

FIG. 4 illustrates a block diagram of a computing system 400 configured to implement or execute the method shown in FIG. 3 and described herein. The computing apparatus 400 includes a processor 402 that may implement or execute some or all of the steps described. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for the methods described in the present invention may be stored.

The removable storage drive 410 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed.

Obviously, many modifications and variations are possible in view of the above teachings. For example, although not specifically discussed for each example where visual feedback is given, blending may be used in the majority of example. To avoid sudden harsh changes in visual feedback, we use a time constant to “blend” in feedback when the user is not well positioned, and similarly unblend the feedback when the user is again well positioned. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method of providing feedback to a participant in a video conference, comprising the steps of:
establishing a video conferencing session between multiple participants,
wherein each participant in the video conferencing session is associated with a video capture device and an audio capture device; and
establishing presentation requirements for each participant, wherein the presentation requirements are associated with the video conferencing session and the video capture and audio capture devices associated with each participant,
wherein responsive to a failure to meet the presentation requirements, feedback is sent to at least a local participant who has failed to meet the presentation requirements.

2. The method recited in claim 1 wherein the feedback sent to the local participant who has failed to meet the presentation requirements is visual feedback.

3. The method recited in claim 2 wherein the visual feedback is a modified view of the remote participants, wherein the modified view is intended to indicate to local participant how he should modify his behavior to meet the presentation requirements.

4. The method recited in claim 3 wherein a parallax effect view of the remote participants is feedback to the local participant when the framing presentation requirement is not met.

5. The method recited in claim 3 wherein the view of the remote participants is faded out when the local participant's framing presentation requirement is not met and faded back in when the local participant's framing requirement is met.

6. The method recited in claim 2 wherein a color indicator is applied to an area of the video frame presented in the video conference as an indicator that a framing presentation requirement is not met.

7. The method recited in claim 2 wherein a non-photo-realistic view of the local participant is feedback when a framing presentation requirement has not been met.

8. The method recited in claim 7 wherein the non photo-realistic view of the local participant is a silhouette.

9. The method recited in claim 7 wherein the non-photo-realistic image can be viewed by the local participant when the framing presentation requirement has been met and also when the framing presentation requirement has not been met.

10. The method recited in claim 2 wherein when the presentation requirement is not met, an image of the local participant replaces the image of the remote participant that is shown when the presentation requirements are met.

11. The method recited in claim 10 wherein the image of the local participant is blended with the image of the remote participants.

12. The method recited in claim 2 wherein when a framing presentation requirement is not met, a cropping region is shown on the feedback, wherein the cropping region indicates the extent to which the local participant is out of frame.

13. The method recited in claim 1 wherein a remote participant can initiate when feedback is sent to the user.

14. The method recited in claim 3 wherein the presentation requirements are framing requirements and wherein the feedback indicates modification of the local participant's proximity to the video capture device.

15. The method recited in claim 1 wherein the feedback is audio feedback.

16. The method recited in claim 15 wherein the feedback is audio instructions to change the local participant's volume when the audio presentation requirements are not met.

17. A computer readable storage medium having computer-readable program instructions stored thereon for causing a computer system to perform a method of providing feedback to a participant in a video conference, the method comprising the steps of
establishing presentation requirements for each participant in a video conferencing session, wherein each participant is associated with a video capture device and an audio capture device, wherein the presentation requirements are associated with the video conferencing session and the video capture and audio capture devices associated with each participant; and
providing feedback to at least a local participant of the video conference, wherein the feedback is responsive to the local participant's failure to meet the presentation requirements of the video conferencing session.

18. An apparatus for providing feedback to a participant in a video conference, the apparatus comprising:
a computer readable storage medium with computer executable instructions stored on the computer readable storage medium, wherein the computer executable instructions implement the steps of,
establishing presentation requirements for each participant in a video conferencing session, wherein each participant is associated with a video capture device and an audio capture device, wherein the presentation requirements are associated with the video conferencing session and the video capture and audio capture devices associated with each participant; and
providing feedback to at least a local participant of the video conference, wherein the feedback is responsive to the local participant's failure to meet the presentation requirements of the video conferencing session.
